(19) United States
(12) Patent Application Publication
(10) Pub. No.: US 2013/0332290 A1
(43) Pub. Date: Dec. 12, 2013

(54) PERSONALIZED ONLINE SHOPPING NETWORK FOR GOODS AND SERVICES

(71) Applicant: Rory W. Medrano, Sunny Isles Beach, FL (US)

(72) Inventor: Rory W. Medrano, Sunny Isles Beach, FL (US)

(21) Appl. No.: 13/493,991

(22) Filed: Jun. 11, 2012

(51) Int. Cl. G06Q 30/02

(52) U.S. Cl. 705/14.73

(57) ABSTRACT

A system comprising an electronic marketplace for connecting individual buyers and sellers of goods and services according to specified criteria using a social networking platform hybridized with a classified advertisement service. A member posts offers of goods and services and/or requests for goods and services into a database of the system. An artificial intelligence correlates matching criteria among offers to purchase and sell and periodically generates reports of matching entries visible to a member on an electronic device such as a personal computer. Aspects of social networking are incorporated which let users connect in permissive social groups and adjust the privacy or visibility of offers and requests.

### BACKGROUND OF THE INVENTION

1. Field of the Invention

The present invention relates to methods and apparatus for electronic commerce online, and more particularly, the present invention relates to commerce automation and, in one exemplary embodiment, to methods and systems to provide wanted ad listings within an e-commerce system for both goods and services.

2. Description of the Related Art

The following review of related art is intended to provide edifying examples of problems and pitfalls in the design and use of electronic commerce systems. The mention of these examples does not constitute an admission that any of the following methods or devices constitute prior art applicable to the present invention. The discussion of the references states what their authors assert, and the applicant reserves the right to challenge the accuracy and pertinency of any of the documents cited herein.

The invention is founded upon two uniquely advantageous features afforded by the internet, which are the democratization of commerce and the digitization of personal identity. The internet democratizes commerce because it virtually eliminates costs and barriers associated with the publication and exchange of information, enabling buyers and sellers of goods and services to seek their desired bargains with maximum efficiency. The internet also provides a medium for storing and customizing personal identities and relationships in constant real-time (“the eternal now”), through the phenomenon known as “social networking.” As if by the operation of Newtonian thermodynamics, the emergence of these unique advantages are being thwarted and resisted by the tendency for social networking sites and commercial platforms to centralize and privatize into monopolistic sites that quickly attain a dominant share of traffic and investment capital, only to begin imposing their own profit-driven and brand-limited strictures and fees upon users. The internet giveth, and the megasite taketh away.

### Social Networks and Electronic Commerce

Consider social networking. A social networking service is an online service, platform, or site that focuses on facilitating the building of social networks or social relations among people who, for example, share interests, activities, backgrounds, or real-life connections. A social network service consists of a representation of each user (often a “profile”), his/her social links, and a variety of additional services. Social networking sites allow users to share ideas, activities, events, and interests within their individual networks. The main types of social networking services are those that contain category places (such as former school year or classmates), means to connect with friends (usually with self-description pages), and a recommendation system linked to trust. Many sites allow users to post blog entries, search for others with similar interests and compile and share lists of contacts. Pew Internet & American Life Project, 47% of American adults say they use at least one social-networking site.

A social network is a social structure made up of a set of actors (such as individuals or organizations) and the mutual ties between these actors. People use social networking sites for meeting new friends, finding old friends, or locating people who have the same problems or interests they have, called niche networking Relationships and friendships formed online or in a certain context may then be carried over to an offline setting or a different context, such as commerce. In the late 1990s, user profiles became a central feature of social networking sites, allowing users to compile lists of “friends” and search for other users with similar interests. New social networking methods were developed by the end of the 1990s, and many sites began to develop more advanced features for users to find and manage friends. Attesting to the rapid increase in social networking sites' popularity, by 2005, it was reported that MySpace was getting more page views than Google. Facebook, launched in 2004, became the largest social networking site in the world in early 2009.

Web-based social networking services make it possible to connect people who share interests and activities across political, economic, and geographic borders. Through e-mail and instant messaging, online communities are created where a gift economy and reciprocal altruism are encouraged through cooperation. Information is particularly suited to gift economy, as information is a nonrival good and can be gifted at practically no cost. At the forefront of emerging trends in social networking sites is the concept of “real-time web” and “location-based.” Real-time allows users to contribute content, which is then broadcast as it is being uploaded—the concept is analogous to live radio and television broadcasts. Twitter set the trend for “real-time” services, wherein users can broadcast to the world what they are doing, or what is on their minds within a 140-character limit. Facebook followed suit with their “Live Feed” where users' activities are streamed as soon as it happens. While Twitter focuses on words, Clixtr, another real-time service, focuses on group photo sharing wherein users can update their photo streams with photos while at an event. Foursquare gained popularity as it allowed for users to “check-in” to places that they are frequenting at that moment. Gowalla is another such service that functions in much the same way that Foursquare does, leveraging the GPS in phones to create a location-based user experience. Facebook, however, remains easily the largest photo sharing site—Facebook application and photo aggregator Pixable estimates that Facebook exceeded 100 billion photos in Summer 2011.

Many social networking services, such as Facebook, provide the user with a choice of who can view their profile. This prevents unauthorized user(s) from accessing their information Facebook's controversial and new “Social Ads” program gives companies access to the millions of profiles in order to tailor their ads to a Facebook user's own interests and hobbies. However, rather than sell actual user information, Facebook sells tracked “social actions.” That is, they track the websites a user uses outside of Facebook through a program called Facebook Beacon. Some companies, such as Monster.com, have been steadily developing a more “socialized” feel to their career center sites to harness some of the power of social networking sites. These more business related sites have their own nomenclature for the most part but the most common naming conventions are “Vocational Networking Sites” or “Vocational Media Networks”, with the former more closely tied to individual networking relationships based on social networking principles. Social media are effective to create brand awareness, as an online reputation management tool, for recruiting, to learn about new technologies and competitors, and as a lead generation tool to intercept potential prospects. Companies are able to drive traffic to their own online sites while encouraging their consumers and clients to have discussions on how to improve or change products or services.

Few social networks currently charge money for membership. Companies such as MySpace and Facebook sell online advertising on their site. Their business model is based upon large membership count, and charging for membership would be counterproductive. Social networks operate under an autonomous business model, in which a social network's members serve dual roles as both the suppliers and the consumers of content. This is in contrast to a traditional business model, where the suppliers and consumers are distinct agents.

Amazon.com holds a patent for a “Social Networking System” based on its ownership of PlanetAll. The patent has garnered attention due to its similarity to the popular social networking site Facebook. Amazon's “Purchase Circles” feature was based on PlanetAll, and some of PlanetAll code was used to improve Amazon's Friends and Favorites area. The only calendar feature that appears to have remained, however, is the date reminder. Facebook holds a patent for its News Feed, described in part as a “computer-implemented method for managing information about relationships in a social network via a social timeline.” Friendster also holds several patents, including one for “social networking.” Even auction giant eBay holds a patent for “sharing shopping information on a network-based social platform.” Other inventions describing either online shopping or online social networking systems include U.S. Pat. No. 8,160,929 to Park et al., issued Apr. 17, 2012, entitled “Local item availability information” (the entirety of which is incorporated by reference herein); U.S. Pat. No. 8,046,265 to Van Luchene et al., issued Oct. 25, 2011, entitled “Systems and methods for facilitating a transaction by matching seller information and buyer information” (the entirety of which is incorporated by reference herein); U.S. Pat. No. 8,032,427 to Spreen et al., issued Oct. 4, 2011, entitled “System for providing localized shopping information” (the entirety of which is incorporated by reference herein); U.S. Pat. No. 8,024,226 to Fusz et al., issued Sep. 20, 2011, entitled “Product exchange system” (the entirety of which is incorporated by reference herein); U.S. Pat. No. 7,970,662 to Calonge, issued Jun. 28, 2011, entitled, “Method for providing online submission of requests for proposals for forwarding to identified vendors” (the entirety of which is incorporated by reference herein); and U.S. Pat. No. 7,962,402 to Eydelman, issued Jun. 14, 2011, entitled “Online system for buyer seller matching and negotiation” (the entirety of which is incorporated by reference herein).

However, there does not currently exist a means for shoppers to request a particular item from a service provider and receive both commercial and individual (i.e., classified ads) offers posted for sale that match the criteria of the request. Furthermore, there does not exist a single service where users or members can buy and sell both goods and services in a single platform.

### SUMMARY OF THE INVENTION

The present invention, to be marketed under the trade name “adsONdemand” satisfies the above needs. Alternative trade names for the system and apparatus of the present invention include “sendMEads,” “create-n-send,” “make-n-send,” “makeANDsend,” and “makeNsend.” Instead of shopping on numerous websites to find goods and services matching specified criteria and providing the lowest available price in a particular zone of availability (i.e., zip code, geographic region, time period, etc.) the person can make a query in the “adsONdemand” system and receive a report locating the offered good or service as it is available in the desired time period and location. Alternatively, the consumer can receive periodic updates whenever matching goods and services become available for sale, barter, or purchase. The invention is also beneficial for sellers in a reciprocal fashion, because they can identify buyers interested in a specific good or service either presently, or at a designated future time. The thematic concept is to let consumers get notified when a product or service is on sale or available for trade based on their interests, geographical location and other criteria in order to significantly reduce junk mail for things that each individual consumer is NOT INTERESTED IN BUYING as well as significantly minimizing the amount of time locating a product or service.

### DEFINITIONS

SELLER: a company or individual that is selling a service or product (includes manufacturers, wholesalers and retailers). BUYER/CONSUMER: a company or individual that purchases, sells, barters a product or service. AD: an advertisement for a product or service. NOTIFICATION: an alert placed by a customer or seller that is seeking to sell, buy, or barter a product or service.

### Goals

To use the web in order to transform the way sales ads reach targeted consumers by “letting them know instantly when a product or a service is available based on city radius or other user criteria.” These ads can be customizable in order to locate a specific consumer based on the consumer's pre-determined criteria—in other words, the consumer will decide which sales ad they will receive (their criteria can be narrow or broad, local, national, or international). Advertisements and/or posted offers will be for products (wholesale and retail, used or new, etc.), services (babysitting, attorney, etc.) as well as for things or services that you want to Barter or Trade for. This web based application would be extremely easy to use, very focused, scalable, cost effective to sellers, environmentally friendly, and would include newer functionalities in the future while significantly reducing the time it takes to locate a product or service, pre-determined by the consumer. Additionally, you can befriend another user (relative, close friend, etc.) which would allow the user to know what another user is looking to buy or sell or trade, and give said gift for his or her birthday, anniversary, baby gift, or just for spontaneity. However the user can also decide keep certain things they want to buy private—such as a sex toy. adsONdemand will also meld with portable devices, such as smart phones and tablets as well as facebook and other social media.

The service accommodates any goods and services, such as: very focused sales ads from local chain stores, supermarkets, realtors, airlines, hotels, car dealers, service providers (cleaners, attorneys, photographers, etc.) and practically anything that can be sold or bartered; online products or services; at locations in or near any city, regardless of the user's proximity to any particular location. Another benefit of being able to befriend another user (e.g., relative, close friend, etc.) is to provide the ability to keep certain things they want to buy private—such as a intimate apparel or gifts for a friend. This product can also be used for large sales transactions between manufactures, wholesalers, farmers, distributors, etc. Example: A farmer in South America grows fresh asparagus and is looking to sell the entire season of asparagus to a wholesaler or distributor in the US. Farmer creates a notification that is forwarded to wholesalers and distributors that are looking for fresh Asparagus.

The forgoing summary has outlined some features consistent with the present invention in order that the following detailed description thereof may be better understood, and in order that the present contribution to the art may be better appreciated. The present invention is not limited in its application, details, or components merely to those set forth in the following description and illustrations. The present invention resides not merely in any one of the features set forth in this specification, but also in the particular combination of all of the features and improvements claimed. Methods and devices consistent with the present invention are capable of other embodiments. Also, the phraseology and terminology employed herein are for the purpose of description and should not be regarded as limiting unless explicitly stated as such.

### DETAILED DESCRIPTION

In a first embodiment, SELLER creates an ad for an item, they would enter its category, sub-category, description, etc. I will use an ad for a 32″ HDTV as an example, description would include but is not limited to: Condition (new, used, refurbished, display model), Type, Brand, Size, Color, Resolution, Features (HDMI, USB, Ethernet, etc.). Where it is available (online only, at the local store based on zip code), Price. Seller would be able to see how many consumers are registered in the entire site or based on other criteria, such as a zip code or city radius (example: 5 mile radius of Miami). Results would depend on how wide or narrow the search criterion is. Seller can also see how many consumers are looking to buy that product or service PRIOR to placing the ad. Example: Based on their criteria (city radius, etc.) they can see how many consumers are looking to buy TVs, Computer, Cell Phones, iPADS, etc. With this search result criteria, they can then decide what product/service they want to offer, where they want to place the ad (geographical location) and how many consumers they want to reach.

Seller can customize their sales ad in numerous ways, to either bring traffic to their store or to their website, by creating the following sales ads: A discount for the first 10 customers, etc.; Offer a Deal of the Day; Clearance Ad; Demo Sale; Going out of Business; Offer a discount if it's the consumers birthday, anniversary, etc; and create an ad or offer for any other reason which would be customized by the seller. CONSUMER may also enter same information listed herein above as well as the notification's expiration date, if applicable. Example, let's say consumer is looking to buy a TV (the same one that he seller listed herein above) within the next 10 days. A buyer cannot create a notification and keep it on the site for 3 months—they will have to renew it. If they have bought what they are looking for, the system will remove the notification. The objective is to have an accurate number of items/services that people still want to buy. For example, if a consumer wants to go to Paris, France for vacation, consumer can create notifications and receive ads for Plane Tickets, Hotels, Car Rentals as well as things that consumer is interested in buying during his travel and when he gets there he knows exactly where to go to buy them. As a further example, the system would accommodate a consumer looking for a travel package deal to Milan, which includes Airfare, Hotel & Car Rental, they specify when they want to travel and the price range they want to pay—as soon as that deal is available, they will get a notification. As a further example, many airlines are losing money because planes are not filled or are more than half fly half empty. Solution—Airline creates an ad that will become active only when 75% of said flight is filled. When a consumer registers and creates an account, they do not have to disclose to the seller, their email, phone number, mailing address, etc. and thus prevent spam and unsolicited mail. adsONdemand can also be used to pair up those that are selling used items as well as those bartering or trading a service in exchange for something else. Example: I am out of a job, but I am good at repairing computers. I create and ad to fix your computer in exchange for the items/services I list. My ad goes out to those that are also interested in bartering based on both of our criteria.

The following is an outline of the structure of the system:

### I. NewUsers Register.

Create username and password

Create Profile

Set Global Options

Manage Social Network Functions
Friend requests, friend lists, look and feel of pages, privacy, etc.

Manage Commerce Functions
Post a request form
Post an offer form
   A. Post a request form

Specify criteria
Item desired (Category, brand, model, condition, etc.)
Price Desired (If barter, specify the offered exchange)
Method of payments
   Cash, Credit, Wire, EFT, Barter
Response Method Options
   Only accept Yes/Agree to request
   Accept private messages from sellers?
Privacy/Visibility of request
Duration of request (up to a maximum cap)
Additional keywords or details (enter any text)

### B. Post Offer Forms.

Item offered (Category, brand, model, condition, etc.)
Price offered (If barter, specify the offered exchange)
Commercial vendors and merchants may upload or provide access to product catalogs. This would be arranged by database communication and automatically filled forms. Commissions may be enforced.
Method of payments
   Cash, Credit, Wire, EFT, Barter
Response Method Options
   Commercial vendors and merchants may provide or demand direct links to their websites or product pages.
   Only accept Yes/Agree to buyer
   Accept private messages from interested buyers?
Privacy/Visibility of offer
Duration of offer (up to a maximum cap)
Additional keywords or details (enter any text)

### II. Users Login to Receive/Check Updates

For each shopper request form at a specified interval, the list of offer forms is parsed and ranked according to matching terms/relevance.

Automatic checks can be performed at specified times without login in if users set their accounts to toggle that option on; users determine frequency of automatic checks and number of results to return.

For each shopper request form, the ranked list of relevant matches is displayed on a report. Generate Report Page in HTML and XML or other appropriate language

### III. Other Independent Functions

Site collects sales data behind the scenes

Sales statistics can be bought and sold by market researchers

Web browser toolbar, Facebook app, desktop widget, iphone/android apps

According to one embodiment of the present disclosure, the network has a client-server and a peer-to peer architecture. The system facilitates shopping activity, in the exemplary form of a network-based marketplace, and a network-based social platform that communicate over a network. In one embodiment, the network-based marketplace and the network-based social platform 13 communicate in peer-to peer architecture via programmatic interfaces. Further, the network-based marketplace and the network-based social platform respectively communicate in client-server architecture with clients. The network-based marketplace provides server-side functionality, via the network the Internet, to one or more client machines. Similarly, the network-based social platform provides server-side functionality, via the Internet, to one or more client machines.

An application program interface (API) server and a web server may be coupled to, and provide programmatic and web interfaces respectively to, one or more application servers. The application servers may host one or more social applications and a network-based marketplace interface module that communicates with a communication module and a processing module. The application servers are, in turn, shown to be coupled to one or more databases servers that facilitate access to one or more databases.

The social applications provide a number of social networking functions and services to users that access the network-based social platform. For example, the social applications may enable a user to store information in a profile that may be viewed at client machines and to selectively grant access to information that appears on the profile to other users who may also view the profile at their client machines. The social applications may provide criteria that may be employed by a user to grant various levels of access to various levels of users. For example, a first user may access profile information associated with a second user responsive to the first user achieving the status of “friend” in relation to a second user. A user may achieve the status of friend by accepting an invitation from another user or by sending a request to a user that subsequently grants the request.

The social applications may further enable third party service providers to add “applications” on the network-based social platform that are utilized by users to interact with other users. For example, a network-based marketplace application may be added by a third party service provider in the form of the network-based marketplace interface module, the communication module, and the processing module that may provide market application services in the network-based social platform environment and may communicate with the network-based marketplace. The network-based social platform may be embodied as FACEBOOK® services.

A web client accesses various marketplace and payment applications via the web interface supported by the web server. Similarly, a programmatic client accesses the various services and functions provided by the marketplace and payment applications via the programmatic interface provided by the API server. The programmatic client may, for example, be a seller application (e.g., the TurboLister application developed by eBay Inc., of San Jose, Calif.) to enable sellers to author and manage listings of items on the marketplace in an off-line manner, and to perform batch-mode communications between the programmatic client 18 and the network-based marketplace.

It will be appreciated that the marketplace applications, payment applications, social applications, the network-based marketplace interface module, the communication module and the processing module may execute on a single platform. Accordingly, in one embodiment, the aforementioned applications/modules may execute on the network-based marketplace and in another embodiment the aforementioned applications/module may execute on the network-based social platform. Also, third party applications executing on a third party server machine, may have programmatic access to the network-based marketplace via the programmatic interface provided by the API server. The third party website may, for example, provide one or more promotional, marketplace or payment functions that are supported by the relevant applications of the network-based marketplace.

It should be emphasized that the above described embodiments of the present invention exemplify some, but not all, possible implementations of the present invention and have been set forth in order to provide a clear understanding of its qualities. Those skilled in the art will appreciate that the conception upon which this disclosure is based may readily be utilized as a basis for designing of other structures, methods, and systems for carrying out the several purposes of the present invention. The following claims should be regarded as encompassing equivalent and various constructions insofar as they do not depart from the spirit and scope of the methods and devices consistent with the present invention.

What is claimed is:

1. A system comprising: a network-based social platform comprising a processor for executing, a list of members, a list of sale offers, a list of purchase requests, and a communication module to receive said sale offers and said purchase requests which are posted by said members, wherein a query from a first user device associated with a first user of the network-based social platform causes an artificial intelligence of the network-based social platform to generate a results list of sale offers and purchase requests which match query criteria presented in query and to display said results list in an interactive report displayed on an electronic device operated by said first user.

2. The system of claim 1, wherein said sale offers and said purchase requests comprise goods and services for barter.

3. The system of claim 1, wherein a processing module is to compare user authorization information associated with a list to information associated with the first user to determine whether the first user is authorized to view the list.

4. The system of claim 2, wherein the user authorization information is selected from a group of user authorization information that includes a marketplace community membership relationship, a friend relationship, a favorite friend relationship, and no relationship.

5. The system of claim 1, further comprising a machine-readable storage medium storing instructions that, when executed by a machine, cause the machine to: at a network-based social platform, receive a request from the first user device associated with the first user of the network-based social platform to view a results list created by the artificial intelligence, the first user uninvolved in creating the results list, the list including items offered for sale on a network-based marketplace; receive item filter information associated with a second user, the item filter information including a preference of the second user for not disclosing an item on the list to the first user; and communicate the list based on the item filter information to the first user device, the communicating configured to allow the first user to add another item to the list at the network-based marketplace via the network-based social platform.
